(19) United States
(12) Patent Application Publication
(10) Pub. No.: US 2019/0232223 A1
(43) Pub. Date: Aug. 1, 2019

(54) EXHAUST GAS TREATMENT APPARATUS

(71) Applicant: Jaguar Land Rover Limited, Coventry, Warwickshire (GB)

(72) Inventors: Lars GEHRKE, Conventry (GB); Jonathan HARTLAND, Coventry (GB); Michael DAVIES, Coventry (GB); David BLAIKLEY, Coventry (GB)

(21) Appl. No.: 16/332,734

(22) PCT Filed: Sep. 15, 2017
(86) PCT No.: PCT/EP2017/073281

§ 371 Date: Mar. 12, 2019

(30) Foreign Application Priority Data
Sep. 30, 2016 (GB) 1616651.4

(51) Int. Cl. B01D 53/94; B01J 23/40; B01J 35/04; B01J 38/02; F01N 3/035; F01N 9/00

(52) U.S. Cl. CPC B01D 53/944; F01N 3/101; B01J 35/04; B01J 38/02; F01N 3/035; F01N 9/002; B01D 2255/1021; B01D 2255/1023; B01D 2255/20723; B01D 2255/915; B01D 2258/014; F01N 2250/02; F01N 2260/06; F01N 2370/02; F01N 2430/02; F01N 2430/06; F01N 2900/08; F01N 2900/1402; B01J 23/40

(57) ABSTRACT

A gasoline particulate filter for an exhaust system of a gasoline internal combustion engine includes a substrate and a catalytic coating disposed on the substrate. The catalytic coating has a carrier and at least one catalytically active ingredient. The catalytic coating has a carrier loading less than or equal to 0.5 g/in³ (0.03 g/cm³), and a catalytically active ingredient loading greater than or equal to 0.01 g/ft³ (0.35 g/m³) and less than 2 g/ft³ (70.63 g/m³).

### TECHNICAL FIELD

The present disclosure relates to exhaust gas treatment apparatus. Particularly, but not exclusively, the present disclosure relates to a gasoline particulate filter; and to a vehicle.

### BACKGROUND

A vehicle having an internal combustion engine typically includes aftertreatment systems for treating exhaust gas expelled during a combustion cycle of the internal combustion engine. The aftertreatment systems are provided in an exhaust system for conveying exhaust gas from the internal combustion engine. It is well known to provide one or more catalytic converter, such as a three-way catalyst (TWC), for oxidising carbon monoxide (CO) and hydrocarbons (HC), and reducing nitrogen oxides (NOx). The exhaust system of a gasoline engine may comprise a starter catalyst and a main catalyst, for example. The aftertreatment system may also include a particulate filter. The particulate filter traps carbonaceous particulate material to prevent them being released to the atmosphere with the exhaust gas. The particulate filter is regenerated by oxidising the carbonaceous particulate material. The oxidation is performed at high temperatures in the presence of oxygen. Oxidisation may occur at temperatures greater than 400° C. but the rate increases exponentially with temperature. The oxidation rate in the temperature range 400° C. to 500° C. may, for example, be relatively slow. At temperatures above 500° C., the oxidation rate is higher and regeneration of the particulate filter may be performed to oxidise accumulated carbonaceous particulate material. With regards gasoline particulate filters, the oxidation temperature is preferably greater than 600° C. for a coated gasoline particulate filter; and preferably greater than 650° C. for an uncoated gasoline particulate filter.

A potential problem with particulate filters is that the flow of exhaust gas may be impeded, resulting in an increased back pressure. Certain internal combustion engines, for example in high performance applications, may be sensitive to exhaust back pressure. In order to reduce back pressure effects, the gasoline particulate filter may be disposed remote from the internal combustion engine, for example in an underfloor position. However, since the gasoline particulate filter is further away from the engine, the operating temperature may not be high enough for the purpose of regeneration. A three-way catalytic coating may be provided on the gasoline particulate filter (a so-called coated gasoline particulate filter) in the form of a washcoat so as to lower the temperature required for regeneration. However, this washcoat has been found to increase the exhaust back pressure across the gasoline particulate filter.

It is an aim of the present invention to provide a gasoline particulate filter which, when in use, has reduced levels of back pressure across it compared with gasoline particulate filters of the prior art, whilst maintaining acceptable regeneration capabilities.

### SUMMARY OF THE INVENTION

Aspects of the present invention relate to a gasoline particulate filter; and to a vehicle as claimed in the appended claims.

According to a further aspect of the present invention there is provided a gasoline particulate filter for an exhaust system of a gasoline internal combustion engine, the gasoline particulate filter comprising:
a substrate; and
a catalytic coating disposed on said substrate, the catalytic coating comprising a carrier and at least one catalytically active ingredient;
wherein the catalytic coating has a catalytically active ingredient loading greater than or equal to 0.01 g/ft³ and less than 5 g/ft³.

At least in certain embodiments the back pressure across the gasoline particulate filter may be reduced while maintaining regeneration capability as a result of the low loading and the omission of the reduction catalytically active ingredient.

The gasoline particulate filter is suitable for trapping carbonaceous particulate material in the exhaust gas from the gasoline internal combustion engine. The gasoline particulate filter is regenerated by oxidising the trapped carbonaceous particulate material. At least in certain embodiments the catalytic coating may be configured to promote oxidation of the carbonaceous particulate material, particularly during lean operation of the gasoline internal combustion engine. The catalytic coating may promote oxidation of carbonaceous particulate material trapped in the gasoline particulate filter. The regeneration of the gasoline particulate filter may be a passive regeneration which occurs during normal operation of the internal combustion engine when the conditions in the gasoline particulate filter are suitable for oxidising the carbonaceous particulate material. Alternatively, or in addition, the regeneration of the gasoline particulate filter may comprise an active regeneration event when the operation of the gasoline internal combustion is controlled to create conditions in the gasoline particulate filter suitable for oxidising the carbonaceous particulate material.

The catalytically active ingredient loading may be less than 5 g/ft³. The catalytically active ingredient loading may be less than or equal to 4 g/ft³, 3 g/ft³, 2 g/ft³ or 1 g/ft³. The catalytically active ingredient loading may be greater than or equal to one or more of the following: 0.01 g/ft³, 0.1 g/ft³, 0.25 g/ft³, 0.5 g/ft³, 0.75 g/ft³ and 1 g/ft³. For example, the catalytically active ingredient loading may be in the range 0.1 g/ft³ to 5 g/ft³ inclusive. The catalytically active ingredient loading may be in one of the following ranges: 0.01 g/ft³ to 4 g/ft³ inclusive; 0.01 g/ft³ to 3 g/ft³ inclusive; and 0.01 g/ft³ to 2 g/ft³ inclusive. The catalytically active ingredient loading may be in the range 1 g/ft³ to 2 g/ft³ inclusive.

The at least one catalytically active ingredient may consist of one or more oxidation catalyst. Thus, at least in certain embodiments, the gasoline particulate filter may only have an oxidation catalyst. At least in certain embodiments, the at least one catalytically active ingredient does not include a reduction catalyst and the catalytic coating does not promote reduction. The one or more oxidation catalyst and/or the catalytically active ingredient loading may be specified to provide effective oxidation of the carbonaceous particulate material trapped in the gasoline particulate filter at a temperature in the range 600° C. to 630° C. More particularly, the one or more oxidation catalyst and/or the catalytically active ingredient loading may be specified to provide effective oxidation of the carbonaceous particulate material trapped in the gasoline particulate filter at a temperature of approximately 600° C.

The one or more oxidation catalyst may comprise a platinum-group metal (PGM). The oxidation catalyst may comprise or consist of Platinum (Pt) and/or Palladium (Pd).

Alternatively, or in addition, the one or more oxidation catalyst may comprise or consist of Vanadia. It has been determined that Vanadia is a suitable catalyst for promoting oxidation of the carbonaceous particulate material trapped in the gasoline particulate

The catalytic coating may have a carrier loading less than or equal to 0.5 g/in³. The carrier loading may be less than or equal to 0.4 g/in³ or 0.3 g/in³. The carrier loading may be approximately 0.2 g/in³.

The catalytic coating may optionally comprise a stabiliser and/or a promoter. Stabilisers and/or promoters typically used in the automotive industry may be used in this application.

The carrier may comprise one or more of the following set: aluminum oxide, titanium dioxide, silicon dioxide, silica and alumina.

According to a further aspect of the present invention there is provided a gasoline particulate filter for an exhaust system of a gasoline internal combustion engine, the gasoline particulate filter comprising:
a substrate; and
a catalytic coating disposed on said substrate;
wherein the catalytic coating comprises at least one catalytically active ingredient, the at least one catalytically active ingredient consisting of one or more oxidation catalyst.

The catalytic coating may have a catalytically active ingredient loading less than or equal to 10 g/ft³. The catalytically active ingredient loading may be less than or equal to one or more of the following: 5 g/ft³, 4 g/ft³, 3 g/ft³, 2 g/ft³ or 1 g/ft³. The catalytically active ingredient loading may be greater than or equal to one or more of the following: 0.01 g/ft³, 0.1 g/ft³, 0.25 g/ft³, 0.5 g/ft³, 0.75 g/ft³ and 1 g/ft³. For example, the catalytically active ingredient loading may be in the range 0.1 g/ft³ to 5 g/ft³ inclusive. The catalytically active ingredient loading may be in one of the following ranges: 0.01 g/ft³ to 4 g/ft³ inclusive; 0.01 g/ft³ to 3 g/ft³ inclusive; and 0.01 g/ft³ to 2 g/ft³ inclusive. The catalytically active ingredient loading may be in the range 1 g/ft³ to 2 g/ft³ inclusive.

The one or more oxidation catalyst may comprise a platinum-group metal (PGM). The one or more oxidation catalyst may comprise or consist of Platinum (Pt) and/or Palladium (Pd).

The catalytic coating comprises a carrier for dispersing the at least one catalytically active ingredient over said substrate. The carrier may be a washcoat. The catalytic coating may have a carrier loading less than or equal to 0.5 g/in³. The carrier loading may be less than or equal to 0.4 g/in³ or 0.3 g/in³. The carrier loading may be approximately 0.2 g/in³.

The catalytic coating comprises a stabiliser and/or a promoter.

According to a further aspect of the present invention there is provided an exhaust system having an aftertreatment system comprising one of more gasoline particulate filter as described herein.

According to a further aspect of the present invention there is provided a system comprising an internal combustion engine and an exhaust system having an aftertreatment system comprising one of more gasoline particulate filter as described herein.

The exhaust system may be connected to the internal combustion engine. In use, exhaust gases from the internal combustion engine may be exhausted to the exhaust system. The internal combustion engine may be configured to operate at stoichiometric conditions. The internal combustion engine may be a stoichiometric gasoline engine (as opposed to a lean-burn gasoline engine). At least in certain embodiments of the present invention, the internal combustion is configured to operate under stochiometric conditions when it is supplied with fuel. Under load, the normal operating mode of the internal combustion engine is stoichiometric. This is in contrast with a lean-burn engine which is configured to operate under lean conditions when it is supplied with fuel. Thus, the internal combustion engine may be a stoichiometric gasoline engine. The regeneration of the gasoline particulate filter according to aspects of the present invention may comprise or consist of passive regeneration. In use, regeneration of the gasoline particulate filter may comprise or consist of passive regeneration when the supply of fuel to the internal combustion engine is inhibited (for example, a fuel-cut event); or the supply of fuel to the internal combustion engine is reduced. When the supply of fuel is inhibited or reduced, oxygen may be available in the exhaust system to oxidise carbonaceous particulate material trapped in the gasoline particulate filter. The gasoline particulate filter may thereby be regenerated passively. For example, the passive regeneration may occur during overrun or when there is a reduction in a torque demand to the internal combustion engine. The torque demand may, for example, be reduced when a driver lifts off an accelerator pedal.

In use, the gasoline particulate filter may be regenerated during a fuel-cut event or an overrun event.

The fuelling of an internal combustion engine to achieve a desired air-fuel ratio may be achieved through closed loop control. To maintain stochiometric operating conditions of the internal combustion engine, the fuel supply to the internal combustion engine may be controlled in dependence on a signal or a plurality of signals received from one or more oxygen sensors disposed in the exhaust system.

At least in certain embodiments, the fuel supply to the internal combustion engine may be determined in dependence on a signal provided by one or more oxygen sensors disposed in the exhaust system. The one or more oxygen sensors may be disposed in the exhaust system upstream of the gasoline particulate filter.

Alternatively, or in addition, one or more oxygen sensors may be disposed in the exhaust system downstream of the gasoline particulate filter. The one or more oxygen sensors may determine when the gasoline particulate filter is consuming oxygen to regenerate. In this implementation, the regeneration of the gasoline particulate filter may not occur during fuel-cut/overrun.

According to a further aspect of the present invention there is provided a vehicle comprising a gasoline particulate filter, an exhaust system, or a system comprising an internal combustion engine and an exhaust system as described herein.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the present invention will now be described, by way of example only, with reference to the accompanying figures, in which:

FIG. 1 shows a schematic representation of a vehicle incorporating an aftertreatment system in accordance with an embodiment of the present invention.

### DETAILED DESCRIPTION

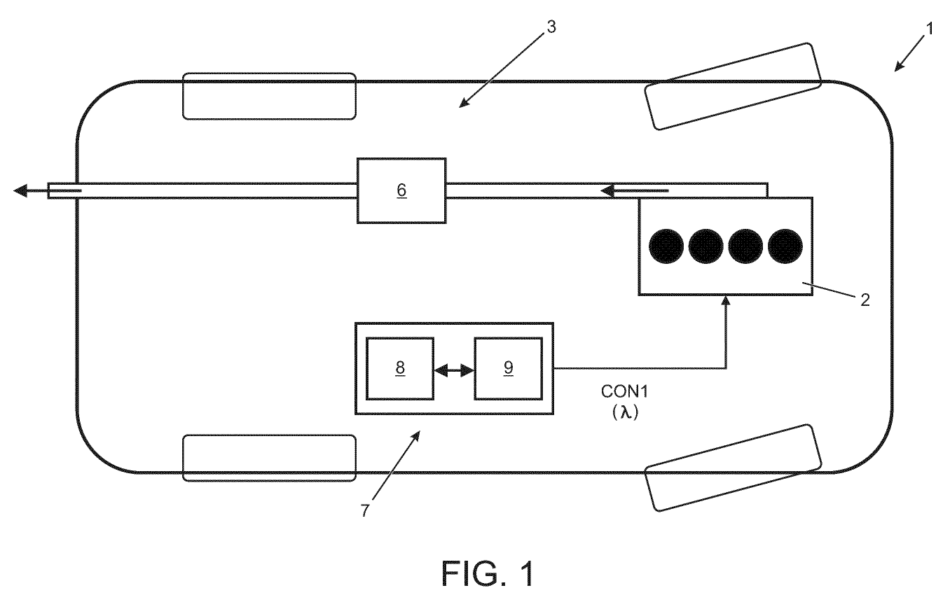

A vehicle 1 in accordance with an embodiment of the present invention is illustrated in FIG. 1. The vehicle 1 comprises an internal combustion engine 2 having an exhaust system 3 for conveying exhaust gas from the internal combustion engine 2. The vehicle 1 in the present embodiment is an automobile, but the present invention may usefully be implemented in other types of vehicle.

The internal combustion engine 2 is a gasoline engine which combusts gasoline in one or more combustion chamber (not shown). In the present embodiment, the internal combustion engine 2 is a gasoline light duty engine adapted to operate at stoichiometric conditions. Exhaust gases from the combustion cycle are expelled from the internal combustion engine 2 into the exhaust system 3 for treatment by aftertreatment systems (denoted by the reference numeral 4) comprising a gasoline particulate filter (GPF) 6. The GPF 6 collects carbonaceous particulate material from the exhaust gas. The carbonaceous particulate material may comprise or consist of soot. The GPF 6 is regenerated by oxidising the trapped carbonaceous particulate material. The oxidation process requires oxygen and a high temperature.

The vehicle 1 comprises an engine control unit 7 for controlling operation of the internal combustion engine 2. The engine control unit 7 comprises a processor 8 connected to a memory device 9. The processor 8 is configured to implement a set of non-transitory computational instructions stored on said memory device 9. When executed, the computational instructions cause the processor to implement an engine control strategy for controlling operation of the internal combustion engine 2. The processor 8 is configured to output a lambda control signal CON1 for controlling lambda (λ) of the internal combustion engine 2. Lambda (λ) is the ratio of the actual air/fuel ratio (AFR) to the stoichiometric air/fuel ratio (AFR_{stoich}) and is defined by the following equation:

$$λ = \frac{AFR}{AFRstoich}$$

As outlined above, the internal combustion engine 2 is configured to operate at stoichiometric conditions, i.e. lambda (λ) is at least substantially equal to one (1). The lambda control signal CON1 may increase or decrease lambda (λ) of the internal combustion engine 2. By varying lambda (λ), the content of the exhaust gas expelled from the internal combustion engine 2 may be selectively controlled. In order to maintain efficient operation of the aftertreatment systems 4, the engine control unit 7 is configured to adjust lambda (λ) to control the oxygen content of the exhaust gas introduced into the exhaust system 3.

The engine control unit 7 is configured to control fuelling of the internal combustion engine 2 to maintain stoichiometric operation (λ=1). There is typically a small amount of oxygen available in the exhaust gas which enables oxidation of carbonaceous particulate material trapped in the GPF 6, provided the temperature of the GPF 6 is high enough. It will be understood that carbon monoxide (CO) and/or unburned hydrocarbons (UHC) may also be oxidised in the GPF 6. However, if there is insufficient oxygen available and/or the temperature of the GPF 6 is not high enough, there may be a build-up of carbonaceous particulate material in the GPF 6 over time. In order to regenerate the GPF 6, the engine control unit 7 is configured to perform an active regeneration event to promote oxidation of the carbonaceous particulate material. The active regeneration event comprises controlling the internal combustion engine 2 to increase the temperature of the exhaust gas introduced into the exhaust system 3 such that the temperature of the GPS 6 is increased. The engine control unit 7 is configured also to increase lambda (λ) of the internal combustion engine 2 resulting in the application of a lean bias. This results in an increase in the oxygen content of the exhaust gas which means that more oxygen is available for oxidation of the carbonaceous particulate material in the GPF 6.

The GPF 6 comprises a substrate, for example a ceramic or metal core. A catalytic coating is applied to the substrate. In accordance with an aspect of the present invention the catalytic coating comprises a carrier and at least one catalytically active ingredient. The catalytic coating is an oxidative coating and the at least one catalytically active ingredient consists of one or more oxidation catalyst. The one or more oxidation catalyst promote oxidation of the carbonaceous particulate material during lean operation of the internal combustion engine 2. In the present embodiment the catalytic coating does not include a reduction catalyst. The catalytic coating does not promote reduction during rich operation of the gasoline internal combustion engine. The GPF 6 is not provided with a reductive coating or equivalent. Thus, the catalytic coating applied to the substrate does not function as a three-way catalyst (TWC).

The carrier is in the form of a washcoat for dispersing the oxidation catalyst over a large surface area of the substrate. The washcoat may, for example, comprise aluminium oxide, titanium dioxide, silicon dioxide, or a mixture of silica and alumina. The one or more oxidation catalyst may comprise a precious metal, for example a platinum-group metal (PGM). The platinum-group metals comprise Ruthenium (Ru), Rhodium (Rd), Palladium (Pd), Osmium (Os), Iridium (Ir), and Platinum (Pt). The oxidation catalyst in the present embodiment comprises or consists of Platinum (Pt) and/or Palladium (Pd). In alternative embodiments the oxidation catalyst may comprise or consist of Gold (Au) and/or Silver (Ag). The one or more oxidation catalyst promotes oxidation of the trapped carbonaceous particulate material. At least in certain embodiments the catalytic coating may enable oxidation of the trapped carbonaceous particulate material at a temperature of approximately 600° C. An equivalent GPF 6 without an oxidation catalyst would have to be heated to a temperature in the range 630° C. to 650° C. in order to perform oxidation at an equivalent rate. It will be understood, therefore, that the catalytic coating enables regeneration of the GPF 6 at a lower temperature. By lowering the temperature at which the carbonaceous particulate material is oxidised, there are increased opportunities to regenerate the GPF 6. The accumulation of carbonaceous particulate material in the GPF 6 may be partially or completely reduced over a wider range of duty cycles, thereby reducing the requirement/frequency of active regeneration events may also be reduced. Moreover, at least in certain embodiments, the active regeneration event may be performed more efficiently due to the lower temperature required for effective oxidation of carbonaceous particulate material in the GPF 6.

The catalytic coating applied to the GPF 6 in accordance with the present embodiment has a low loading. The carrier loading is low and/or the catalytically active ingredient loading is low. The carrier loading is less than or equal to 0.5 g/in³. More particularly, the carrier loading in the present embodiment is approximately 0.2 g/in³. The catalytically active ingredient loading is in the range 0.1 g/ft³ to 5 g/ft³, inclusive. More particularly, the catalytically active ingredient loading in the present embodiment is in the range 1 g/ft³ to 2 g/ft³, inclusive. By reducing the carrier loading and/or the catalytically active ingredient loading, any increase in backpressure in the exhaust system 3 may be reduced or minimised.

The engine control unit 7 is configured to control the internal combustion engine 2 during an active regeneration event to raise the temperature of the GPF 6 to approximately 600° C. The provision of the one or more oxidation catalyst helps to ensure that this temperature is sufficient for regeneration of the GPF 6 since the carbonaceous particulate material is oxidised.

It will be appreciated that various changes and modifications may be made to the engine control unit 7 described herein without departing from the scope of the present invention. The present invention has been described with particular reference to a gasoline light duty engine 2 adapted to operate at stoichiometric conditions. It will be understood that the present invention can be used in conjunction with spark-ignition internal combustion engines 2 which combust fuels other than gasoline under stoichiometric conditions. For example, the internal combustion engine 2 could be adapted to use compressed natural gas (CNG), alcohol or liquefied petroleum gas (LPG) as a fuel source.

1. A gasoline particulate filter for an exhaust system of a gasoline internal combustion engine, the gasoline particulate filter comprising:
a substrate; and
a catalytic coating disposed on said substrate, the catalytic coating comprising a carrier and at least one catalytically active ingredient;
wherein the catalytic coating has a catalytically active ingredient loading greater than or equal to 0.01 g/ft³ (0.35 g/m³) and less than 2 g/ft³ (70.63 g/m³), and wherein the catalytic coating has a carrier loading less than or equal to 0.5 g/in³ (0.03 g/cm³).

2. The gasoline particulate filter as claimed in claim 1, wherein the catalytically active ingredient loading is less than or equal to 1 g/ft³ (0.35 g/m³).

3. The gasoline particulate filter as claimed in claim 1, wherein the catalytically active ingredient loading is greater than or equal to one or more of the following: 0.1 g/ft³ (3.53 g/m³), 0.25 g/ft³ (8.83 g/m³), 0.5 g/ft³ (17.66 g/m³), 0.75 g/ft³ (26.49 g/m³) and 1 g/ft³ (35.31 g/m³).

4. The gasoline particulate filter as claimed in claim 1, wherein the at least one catalytically active ingredient consists of one or more oxidation catalyst.

5. The gasoline particulate filter as claimed in claim 4, wherein the one or more oxidation catalyst comprises a platinum-group metal.

6. The gasoline particulate filter as claimed in claim 5, wherein the oxidation catalyst consists of Platinum and/or Palladium.

7. (canceled)

8. The gasoline particulate filter as claimed in claim 6, wherein the carrier loading is 0.2 g/in³ (0.01 g/cm³).

9. The gasoline particulate filter as claimed in claim 1, wherein the catalytic coating comprises a stabiliser and/or a promoter.

10. An exhaust system having an aftertreatment system comprising one or more gasoline particulate filter as claimed in claim 1.

11. A system comprising an internal combustion engine and the exhaust system as claimed in claim 10.

12. The system as claimed in claim 11, wherein the internal combustion engine is configured to operate at stoichiometric conditions.

13. The system as claimed in claim 11, wherein, in use, the gasoline particulate filter is regenerated during a fuel-cut event or an overrun event.

14. A vehicle comprising the gasoline particulate filter as claimed in claim 1.
